(19) United States
(12) Patent Application Publication
(10) Pub. No.: US 2013/0148107 A1
(43) Pub. Date: Jun. 13, 2013

(54) MULTI-SOURCE SENSOR FOR ONLINE CHARACTERIZATION OF WEB PRODUCTS AND RELATED SYSTEM AND METHOD

(71) Applicants: Sebastien Tixier, North Vancouver (CA); Frank M. Haran, North Vancouver (CA)

(72) Inventors: Sebastien Tixier, North Vancouver (CA); Frank M. Haran, North Vancouver (CA)

(73) Assignee: Honeywell ASCA Inc., Mississauga (CA)

(21) Appl. No.: 13/314,030

(22) Filed: Dec. 7, 2011

(51) Int. Cl. G01N 21/86; G01N 21/00; H05B 37/02

(52) U.S. Cl. 356/73; 315/312; 356/429

(57) ABSTRACT

A system includes a first sensor unit having multiple solid-state light sources each configured to generate light at one or more wavelengths, where different light sources are configured to generate light at different wavelengths. The first sensor unit also includes a mixer configured to mix the light from the light sources and to provide the mixed light to a web being sampled. The first sensor unit further includes a controller configured to control the generation of the light by the light sources. The system also includes a second sensor unit comprising a detector configured to measure mixed light that has interacted with the web. The second sensor unit could also include a second controller configured to determine one or more characteristics of the web (such as moisture content and fiber weight) using measurements from the detector.

### TECHNICAL FIELD

This disclosure relates generally to control systems. More specifically, this disclosure relates to a multi-source sensor for online characterization of web products and related system and method.

### BACKGROUND

Sheets or other webs of material are used in a variety of industries and in a variety of ways. These materials can include paper, multi-layer paperboard, and other products manufactured or processed in long webs. As a particular example, long sheets of paper can be manufactured and collected in reels. These webs of material are often manufactured or processed at high rates of speed, such as speeds of up to one hundred kilometers per hour or more.

It is often necessary or desirable to measure one or more properties of a web of material as the web is being manufactured or processed. For example, it is often desirable to measure the properties of a paper sheet being manufactured (such as its moisture, coat weight, basis weight, color, or caliper/thickness) to verify whether the sheet is within certain specifications. Adjustments can then be made to the sheet-making process to ensure that the sheet properties are within the desired range(s).

Together with basis weight or fiber weight, online moisture measurements are often one of the most important measurements for quality control in a paper-making or other web-making process. Online moisture measurements often need to be accurate, fast, and at a high resolution (such as 5mm or less in the cross-direction across a web). Online moisture sensors also typically need to provide stable and reliable measurements for years of service with minimal maintenance. Traditional moisture sensors use broadband light sources such as Quartz Tungsten Halogen (QTH) bulbs. Although QTH light sources provide the necessary light intensity for accurate measurements, they typically suffer from a number of limitations.

### SUMMARY

This disclosure provides a multi-source sensor for online characterization of web products and related system and method.

In a first embodiment, an apparatus includes multiple solid-state light sources each configured to generate light at one or more wavelengths, where different light sources are configured to generate light at different wavelengths. The apparatus also includes a mixer configured to mix the light from the light sources and to provide the mixed light to a web being sampled. The apparatus further includes a controller configured to control the generation of the light by the light sources.

In a second embodiment, a system includes a first sensor unit having multiple solid-state light sources each configured to generate light at one or more wavelengths, where different light sources are configured to generate light at different wavelengths. The first sensor unit also includes a mixer configured to mix the light from the light sources and to provide the mixed light to a web being sampled. The first sensor unit further includes a controller configured to control the generation of the light by the light sources. The system also includes a second sensor unit comprising a detector configured to measure mixed light that has interacted with the web.

In a third embodiment, a method includes generating light at different wavelengths using multiple solid-state light sources, mixing the light from the light sources, and providing the mixed light to a web being sampled. The method also includes controlling the generation of the light by the light sources.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example web manufacturing or processing system according to this disclosure;

FIGS. 2A and 2B illustrate example sensors having solid-state light sources according to this disclosure;

FIGS. 3 through 5 illustrate various other arrangements of sensors having solid-state light sources according to this disclosure; and

FIG. 6 illustrates an example method for sensing web characteristics using sensors having solid-state light sources according to this disclosure.

### DETAILED DESCRIPTION

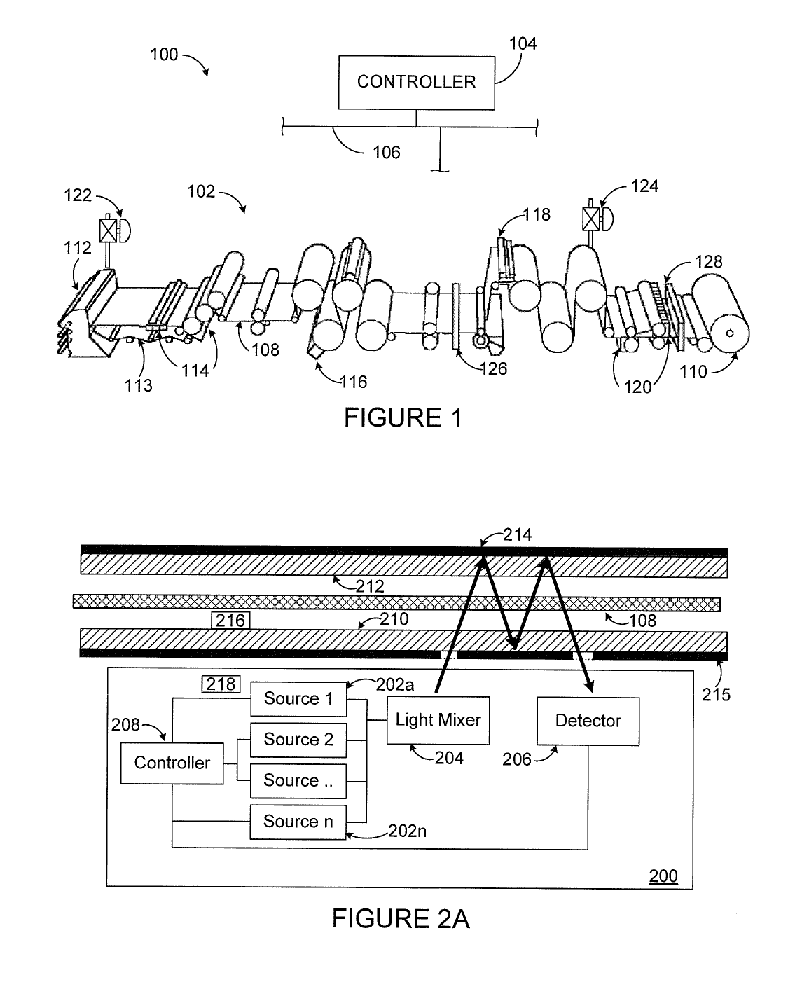

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example web manufacturing or processing system 100 according to this disclosure: In this example, the system 100 includes a paper machine 102, a controller 104, and a network 106. The paper machine 102 includes various components used to produce a paper product, namely a paper web 108 that is collected at a reel 110. The controller 104 monitors and controls the operation of the paper machine 102, which may help to maintain or increase the quality of the paper web 108 produced by the paper machine 102.

In this example, the paper machine 102 includes at least one headbox 112, which distributes a pulp suspension uniformly across the machine onto a continuous moving wire screen or mesh 113. The pulp suspension entering the headbox 112 may contain, for example, 0.2-3% wood fibers, fillers, and/or other materials, with the remainder of the suspension being water. The headbox 112 may include an array of dilution actuators, which distributes dilution water into the pulp suspension across the web. The dilution water may be used to help ensure that the resulting paper web 108 has a more uniform basis weight across the web 108.

Arrays of drainage elements 114, such as vacuum boxes, remove as much water as possible to initiate the formation of the sheet 108. An array of steam actuators 116 produces hot steam that penetrates the paper web 108 and releases the latent heat of the steam into the paper web 108, thereby increasing the temperature of the paper web 108 in sections across the web. The increase in temperature may allow for easier removal of remaining water from the paper web 108. An array of rewet shower actuators 118 adds small droplets of water (which may be air atomized) onto the surface of the paper web 108. The array of rewet shower actuators 118 may be used to control the moisture profile of the paper web 108, reduce or prevent over-drying of the paper web 108, or correct any dry streaks in the paper web 108.

The paper web 108 is then often passed through a calender having several nips of counter-rotating rolls. Arrays of induction heating actuators 120 heat the shell surfaces of various ones of these rolls. As each roll surface locally heats up, the roll diameter is locally expanded and hence increases nip pressure, which in turn locally compresses the paper web 108. The arrays of induction heating actuators 120 may therefore be used to control the caliper (thickness) profile of the paper web 108. The nips of a calender may also be equipped with other actuator arrays, such as arrays of air showers or steam showers, which may be used to control the gloss profile or smoothness profile of the paper web.

Two additional actuators 122-124 are shown in FIG. 1. A thick stock flow actuator 122 controls the consistency of incoming stock received at the headbox 112. A steam flow actuator 124 controls the amount of heat transferred to the paper web 108 from drying cylinders. The actuators 122-124 could, for example, represent valves controlling the flow of stock and steam, respectively. These actuators may be used for controlling the dry weight and moisture of the paper web 108.

Additional components could be used to further process the paper web 108, such as a supercalender (for improving the paper web's thickness, smoothness, and gloss) or one or more coating stations (each applying a layer of coatant to a surface of the paper to improve the smoothness and printability of the paper web). Similarly, additional flow actuators may be used to control the proportions of different types of pulp and filler material in the thick stock and to control the amounts of various additives (such as retention aid or dyes) that are mixed into the stock.

This represents a brief description of one type of paper machine 102 that may be used to produce a paper product. Additional details regarding this type of paper machine 102 are well-known in the art and are not needed for an understanding of this disclosure. Also, this represents one specific type of paper machine 102 that may be used in the system 100. Other machines or devices could be used that include any other or additional components for producing a paper product. In addition, this disclosure is not limited to use with systems for producing paper products and could be used with systems that process a paper product or with systems that produce or process other items or materials (such as multi-layer paperboard, cardboard, plastic, textiles, metal foil or webs, or other or additional materials that are manufactured or processed as moving webs).

In order to control the paper-making process, one or more properties of the paper web 108 may be continuously or repeatedly measured. The web properties can be measured at one or various stages in the manufacturing process. This information may then be used to adjust the paper machine 102, such as by adjusting various actuators within the paper machine 102. This may help to compensate for any variations of the web properties from desired targets, which may help to ensure the quality of the web 108.

As shown in FIG. 1, the paper machine 102 includes one or more sensor arrays 126-128, each of which may include one or more sensors. Each sensor array 126-128 is capable of measuring one or more characteristics of the paper web 108. For example, each sensor array 126-128 could include sensors for measuring the moisture, basis weight, caliper, coat weight, anisotropy, color, gloss, sheen, haze, fiber orientation, surface features (such as roughness, topography, or orientation distributions of surface features), or any other or additional characteristics of the paper web 108.

Each sensor array 126-128 includes any suitable structure or structures for measuring or detecting one or more characteristics of the paper web 108. The sensors in a sensor array 126-128 could be stationary or scanning sensors. Stationary sensors could be deployed in one or a few locations across the web 108, or they could be deployed at multiple locations across the whole width of the web 108 such that substantially the entire web width is measured. A scanning set of sensors could include any number of moving sensors.

The controller 104 receives measurement data from the sensor arrays 126-128 and uses the data to control the paper machine 102. For example, the controller 104 may use the measurement data to adjust any of the actuators or other components of the paper machine 102. The controller 104 includes any suitable structure for controlling the operation of at least part of the paper machine 102, such as a computing device.

The network 106 is coupled to the controller 104 and various components of the paper machine 102 (such as the actuators and sensor arrays). The network 106 facilitates communication between components of the system 100. The network 106 represents any suitable network or combination of networks facilitating communication between components in the system 100. The network 106 could, for example, represent a wired or wireless Ethernet network, an electrical signal network (such as a HART or FOUNDATION FIELDBUS network), a pneumatic control signal network, or any other or additional network(s).

As noted above, accurate moisture measurements are often needed or desired for quality control in web-making or web-processing systems. Traditional moisture sensors use broadband light sources such as Quartz Tungsten Halogen (QTH) bulbs. However, QTH light sources typically suffer from a number of limitations. For example, QTH light sources often cannot be directly modulated at high frequencies. This means that a mechanical chopper is often used in order to support synchronous detection techniques, but moving parts commonly lead to maintenance issues. Also, QTH light sources often have limited operational lifespans and usually require a significant number of replacements during the sensor's lifetime. In addition, QTH light sources may show instability close to their end of life.

In accordance with this disclosure, a multi-source sensor (such as a sensor used in the array 126 and/or 128) employs multiple solid-state light sources at various wavelengths to measure web properties. Solid-state light sources can include sources such as light emitting diodes (LEDs), super-luminescent LEDs (SLEDS), and laser diodes. These solid-state light sources can be directly modulated at very high frequencies, so no mechanical chopper may be needed, and measurement speeds can be increased (such as by several orders of magnitude). Also, solid-state light sources are typically stable, require little or no maintenance, and have very long operational lifespans (possibly matching a sensor's lifespan). In addition, the central wavelength of a solid-state light source can be tuned very precisely, such as by changing the source's operating temperature. This could be done, for example, to substantially match the light source's emissions to a characteristic absorption feature of a web product and to tune this emission depending on the web product's production temperature.

A sensor can include any number of solid-state light sources. For example, some embodiments of a moisture and fiber weight sensor could include two, three, or four solid-state light sources. A different number of sources may be used for other applications, such as when more sources are used for the measurement of coat weight applied to paper products. Light from multiple solid-state sources can be brought together and mixed before being directed to the web 108. Various types of mixers can be used, such as fiber optics, fiber bundles, or light guides. Only one detector may be needed to receive and measure the light that has interacted with the web 108. The solid-state light sources can be modulated at various frequencies (including very high frequencies) in any suitable manner, such as by using frequency division multiplexing or time division multiplexing, so that the light can be demodulated by a detector or other receiver.

A sensor can also include additional types of light sources, such as thermal sources, MEMS sources, and/or QTH sources. These sources do not have all the advantages of solid-state sources but could complement solid-state sources in some applications, such as when a broadband illumination is required.

Additional details regarding the use of solid-state light sources in moisture and fiber weight sensors or other web sensors are provided below. Note that while a sensor with solid-state light sources is described here as being used in the sensor array 126 and/or 128, this type of sensor could be used in any other or additional location(s).

Although FIG. 1 illustrates one example of a web manufacturing or processing system 100, various changes may be made to FIG. 1. For example, other systems could be used to produce paper products or other products. Also, while shown as including a single paper machine 102 with various components and a single controller 104, the production system 100 could include any number of paper machines or other production machinery having any suitable structure, and the system 100 could include any number of controllers. In addition, FIG. 1 illustrates one operational environment in which sensors having solid-state light sources can be used. This functionality could be used in any other suitable system.

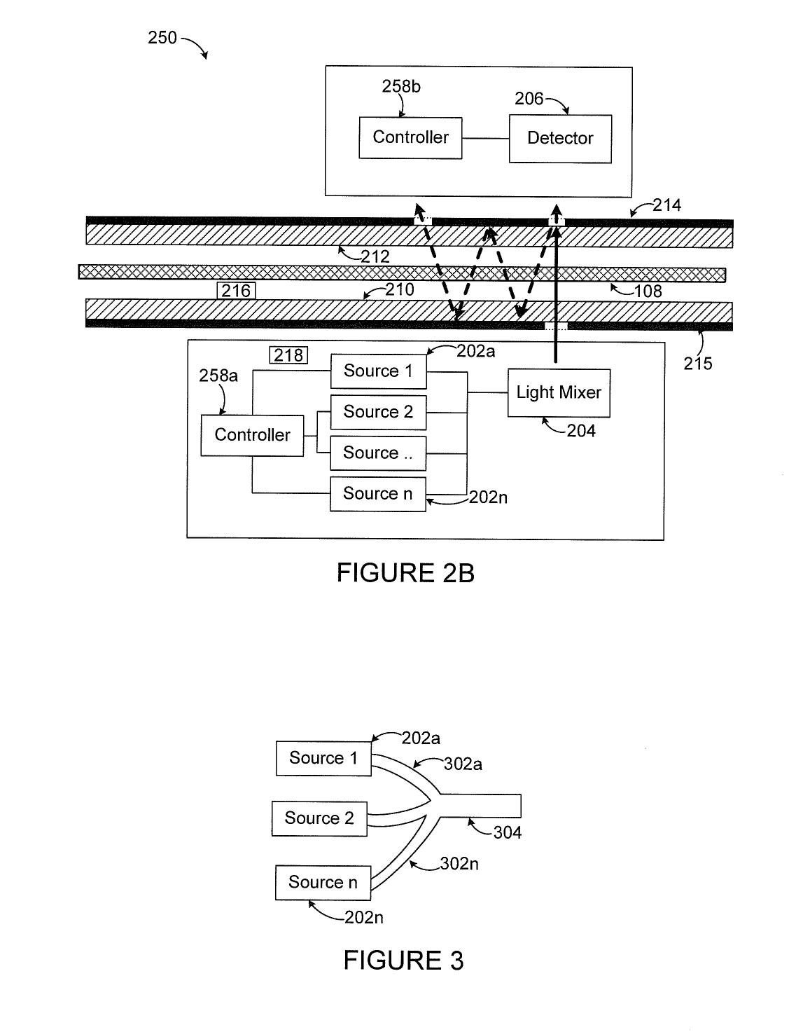

FIGS. 2A and 2B illustrate example sensors having solid-state light sources according to this disclosure. As shown in FIG. 2A, a sensor 200 includes multiple solid-state light sources 202a-202n. Each light source 202a-202n includes any suitable semiconductor structure for generating light at one or more frequencies. As noted above, for example, the light sources 202a-202n could represent LEDs, SLEDs, or laser diodes. Also note that any suitable light can be generated by the light sources 202a-202n, such as visible, infrared, or ultraviolet light. In particular embodiments, the light sources 202a-202n generate light at infrared frequencies like 1.44 μm, 1.49 μm, 1.84 μm, 1.94 μm, and 2.13 μm. In addition, thermal sources, MEMS sources, or QTH sources can also be used.

Light from two or more light sources 202a-202n is combined in a mixer 204. The mixer 204 represents any suitable structure for combining light from multiple sources, such as fiber optics, fiber bundles, or a light guide. Note that if light from a single light source 202a-202n is needed, the mixer 204 could pass the light from that source without mixing.

Light from the mixer 204 is provided to the web 108, and light that has interacted with the web 108 is received at a detector 206. The detector 206 measures one or more characteristics of the light that has interacted with the web 108. For example, the detector 206 could measure the intensity of the received light at multiple wavelengths or in multiple wavelength bands. The detector 206 includes any suitable structure for measuring light, such as a photodetector or spectrometer.

In this example, the light sources 202a-202n are controlled by a controller 208, which also analyzes measurements from the detector 206 to determine the moisture content, fiber weight, or other characteristic(s) of the web 108. The controller 208 can use any suitable mechanism to control the light sources 202a-202n, such as frequency division multiplexing or time division multiplexing of light sources. Frequency division multiplexing of light sources refers to modulating the sources at different frequencies, whereas time division multiplexing of light sources refers to generating light having different wavelengths at different times. The controller 208 can also perform any suitable calculations to determine the moisture content, fiber weight, or other characteristic(s) of the web 108 based on measurements from the detector 206.

The controller 208 includes any suitable structure for controlling light sources and determining one or more characteristics of a web. For example, the controller 208 could include at least one microprocessor, microcontroller, digital signal processor (DSP), field programmable gate array (FPGA), application specific integrated circuit (ASIC), or other processing device. Note that while a single controller 208 is shown here, the functionality of the controller 208 could be distributed across multiple devices. As a particular example, one control unit could control the light sources 202a-202n, while another control unit could determine one or more characteristics of a web.

In this example, light from the mixer 204 passes through a first diffusing window 210 before reaching the web 108. The light passes through the web 108 and then through a second diffusing window 212. The diffusing windows 210-212 represent any suitable structures for diffusing light. Note, however, that one or both diffusing windows 210-212 could be omitted. Also, reflectors 214-215 allow the light to pass multiple times through the web 108 before reaching the detector 206. Each reflector 214-215 represents any suitable structure for substantially reflecting light. The reflector 215 also includes windows or openings that allow the light to pass to and from the web 108.

As noted above, one or more of the solid-state light sources 202a-202n can be tuned very precisely, such as by changing the source's operating temperature. This could be done to match the light source's emissions to a characteristic absorption feature of the web 180 and to tune this emission depending on the web's production temperature. To support this functionality, at least one temperature sensor 216 can be provided in the sensor 200. The temperature sensor 216 can measure the temperature of the web 108 or the surrounding environment, and the measured temperature can be provided to the controller 208 for use in controlling the light sources 202a-202n. The temperature sensor 216 includes any suitable structure for measuring the temperature of a web or specified environment. A commonly-used sheet temperature sensor is an infrared sensor. Note that the temperature sensor 216 could be placed in any suitable location and need not be connected to or embedded within a diffusing window. Also, one or more temperature units 218 could be used to adjust the temperature(s) of the light source(s) 202a-202n. Each temperature unit 218 represents any suitable structure for heating and/or cooling at least one light source.

Note that in FIG. 2A, the light sources and the receiver (detector) are located on the same side of the web 108. FIG. 2B illustrates an example sensor 250 where the light sources and the receiver (detector) are located on opposite sides of the web 108. In this example, a first unit includes the light sources 202a-202n, the light mixer 204, and a controller 258a (which controls the light sources 202a-202n). A second unit includes the detector 206 and a second controller 258b (which determines one or more characteristics of the web 108). In this example, the temperature sensor 216 can provide temperature measurements to either or both controllers 258a-258b. Also, in this example, the detector 206 is located immediately across from the light source 204, although the detector 206 could be located in a location offset from the light source 204. The reflector 214 in FIG. 2B includes windows for both positions, although only one might be present.

The sensors 200, 250 can use the light sources 202a-202n to generate light at any suitable wavelengths or in any suitable wavelength bands. Also, the light generated by the light sources 202a-202n can be mixed, modulated, or used in any suitable manner as needed by the particular measurements being taken by the sensors 200, 250.

Although FIGS. 2A and 2B illustrate examples of sensors having solid-state light sources, various changes may be made to FIGS. 2A and 2B. For example, the layout and arrangement of each sensor 200, 250 are for illustration only. Also, each sensor 200 and 250 could include any number of each component, and various components can be omitted (such as the temperature sensor 216 and/or the temperature unit 218).

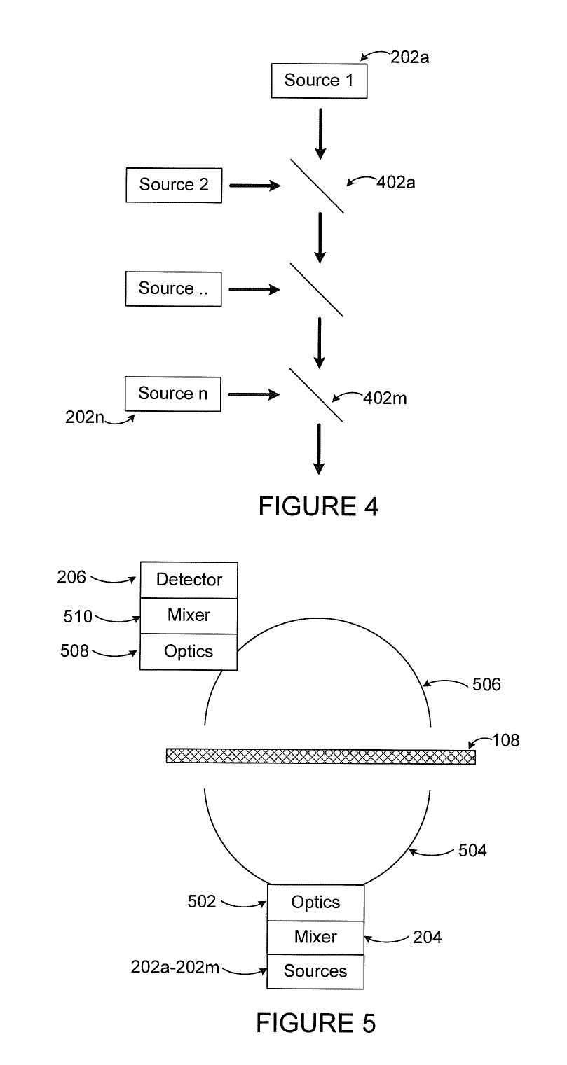

FIGS. 3 through 5 illustrate various other arrangements of sensors having solid-state light sources according to this disclosure. In FIG. 3, the light sources 202a-202n are configured to provide light to optical fibers 302a-302n, which are connected to a larger optical fiber 304. Light from the light sources 202a-202n is mixed within the optical fibers and then delivered to the web 108.

In FIG. 4, the light sources 202a-202n are arranged to operate with multiple dichroic beamsplitters 402a-402m that collectively act as a mixer. Each beamsplitter 402a-402m allows light from one or more prior sources to be combined with light from an additional light source. Each beamsplitter 402a-402m includes any suitable dichroic structure for combining light from multiple sources.

In FIG. 5, the light sources 202a-202n and mixer 204 provide light to the web 108 through optics 502 and a first hemisphere 504. The optics 502 can distribute the light entering the first hemisphere 504, and the first hemisphere 504 can help to focus the light onto a specific portion of the web 108. The light is received at a second hemisphere 506, which can provide at least some of the light to optics 508. The optics 508 provide the captured light to a mixer 510, which ensures that the light is suitably mixed for measurement by the detector 206.

Although FIGS. 3 through 5 illustrate examples of various other arrangements of sensors having solid-state light sources, various changes may be made to FIGS. 3 through 5. For example, a sensor could incorporate any combination of the features shown in FIGS. 2A through 5.

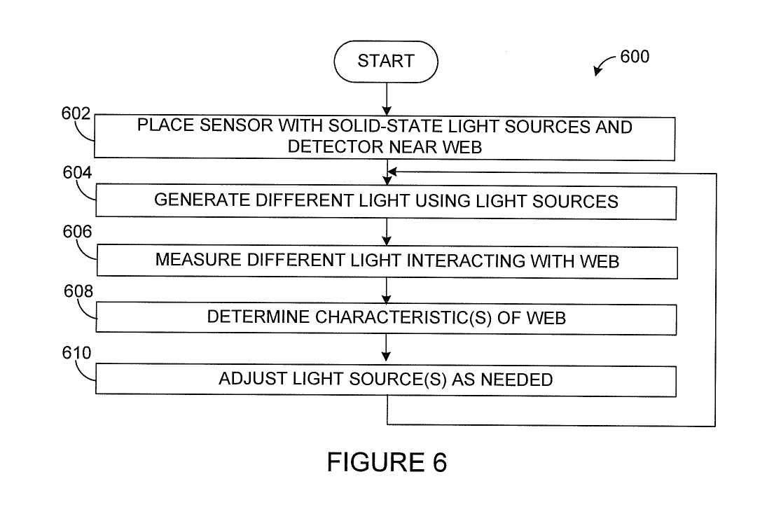

FIG. 6 illustrates an example method 600 for sensing web characteristics using sensors having solid-state light sources according to this disclosure. As shown in FIG. 6, the method 600 includes placing a sensor with multiple solid-state light sources and at least one detector near a web at step 602. This could include, for example, mounting a moving or stationary sensor 200, 250 near the web 108 within the sensory array 126 or 128 of the system 100.

Different light is generated using the light sources of the sensor at step 604. This could include, for example, the sensor using different light sources 202a-202n to generate light at different wavelengths or in wavelength bands. This could also include the controller in the sensor 200, 250 controlling the light sources 202a-202n using frequency division or time division multiplexing techniques. The different light that has interacted with the web is measured at step 706, and one or more characteristics of the web are determined using the measurements at step 708. This could include, for example, a controller determining a moisture content, a fiber weight, or other characteristic(s) of the web 108 using measurements of infrared or other light that has interacted with the web 108.

One or more of the light sources can be adjusted as needed at step 610. This could include, for example, adjusting the wavelength(s) of light emitted by one or more of the light sources 202a-202n. As a particular example, this can include receiving temperature measurements of the web 108 and then changing a light source's operating temperature to match the light source's emissions to a characteristic absorption feature of the web 108. The method 600 can then return to step 604 to continue generating light.

Note that during the method 600, the light sources can be directly modulated at very high frequencies, and rapid measurements can be taken of the web 108. Also, the use of solid-state light sources can provide stable operation with little or no maintenance over a very long operational lifespan. In addition, the central wavelengths of the light sources can be tuned very precisely to achieve more accurate results.

Although FIG. 6 illustrates one example of a method 600 for sensing web characteristics using sensors having solid-state light sources, various changes may be made to FIG. 6. For example, while shown as a series of steps, various steps in FIG. 6 could overlap, occur in parallel, occur in a different order, or occur any number of times. Also, the method 600 could involve the use of any number of sensors, each having any number of light sources.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “obtain” and its derivatives refer to any acquisition of data or other tangible or intangible item, whether acquired from an external source or internally (such as through internal generation of the item). The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define Or constrain this disclosure. Other changes, substitutions, and alterations are also possible without departing from the spirit and scope of this disclosure, as defined by the following claims.

What is claimed is:

1. An apparatus comprising:
multiple solid-state light sources each configured to generate light at one or more wavelengths, different light sources configured to generate light at different wavelengths;
a mixer configured to mix the light from the light sources and to provide the mixed light to a web being sampled; and
a controller configured to control the generation of the light by the light sources.

2. The apparatus of claim 1, wherein the controller is configured to control the one or more wavelengths at which each of the light sources generates light.

3. The apparatus of claim 2, further comprising:
a temperature sensor configured to measure a temperature associated with the web;
wherein the controller is configured to adjust the one or more wavelengths at which at least one of the light sources generates light based on temperature measurements from the sensor.

4. The apparatus of claim 3, wherein the controller is configured to adjust the one or more wavelengths at which one of the light sources generates light by altering a temperature of that light source so that the light source's light substantially matches a characteristic absorption feature of the web.

5. The apparatus of claim 1, further comprising:
a detector configured to measure mixed light that has interacted with the web.

6. The apparatus of claim 5, wherein the controller or a second controller is configured to determine one or more characteristics of the web using measurements from the detector.

7. The apparatus of claim 6, wherein the controller or the second controller is configured to determine a moisture content and a fiber weight of the web.

8. The apparatus of claim 1, wherein the light sources comprise at least one of: light emitting diodes, super-luminescent light emitting diodes, and laser diodes.

9. A system comprising:
a first sensor unit comprising:
multiple solid-state light sources each configured to generate light at one or more wavelengths, different light sources configured to generate light at different wavelengths;
a mixer configured to mix the light from the light sources and to provide the mixed light to a web being sampled; and
a controller configured to control the generation of the light by the light sources; and
a second sensor unit comprising a detector configured to measure mixed light that has interacted with the web.

10. The system of claim 9, wherein the controller is configured to control the one or more wavelengths at which each of the light sources generates light.

11. The system of claim 10, further comprising:
a temperature sensor configured to measure a temperature associated with the web;
wherein the controller is configured to adjust the one or more wavelengths at which at least one of the light sources generates light based on temperature measurements from the sensor.

12. The system of claim 11, wherein the controller is configured to adjust the one or more wavelengths at which one of the light sources generates light by altering a temperature of that light source so that the light source's light substantially matches a characteristic absorption feature of the web.

13. The system of claim 9, wherein the second sensor unit comprises a second controller configured to determine one or more characteristics of the web using measurements from the detector.

14. The system of claim 13, wherein the second controller is configured to determine a moisture content and a fiber weight of the web.

15. The system of claim 9, wherein the light sources comprise at least one of: light emitting diodes, super-luminescent light emitting diodes, and laser diodes.

16. The system of claim 9, wherein the controller is configured to activate the light sources using frequency division or time division multiplexing.

17. A method comprising:
generating light at different wavelengths using multiple solid-state light sources;
mixing the light from the light sources;
providing the mixed light to a web being sampled; and
controlling the generation of the light by the light sources.

18. The method of claim 17, wherein controlling the generation of the light comprises controlling the one or more wavelengths at which each of the light sources generates light.

19. The method of claim 18, further comprising:
receiving measurements of a temperature associated with the web;
wherein controlling the one or more wavelengths at which each of the light sources generates light comprises adjusting the one or more wavelengths at which at least one of the light sources generates light based on the measurements.

20. The method of claim 17, further comprising:
determining a moisture content and a fiber weight of the web using measurements of mixed light that has interacted with the web.
